(19) United States
(12) Patent Application Publication
(10) Pub. No.: US 2020/0175081 A1
(43) Pub. Date: Jun. 4, 2020

(54) SERVER, METHOD AND SYSTEM FOR PROVIDING INFORMATION SEARCH SERVICE BY USING SHEAF OF PAGES

(71) Applicant: SEARCH SOLUTIONS CO., LTD., Seongnam (KR)

(72) Inventors: Se-dong Nam, Seoul (KR); Joong-ho Shin, Seoul (KR)

(21) Appl. No.: 16/681,183

(22) Filed: Nov. 12, 2019

Related U.S. Application Data
(63) Continuation of application No. 11/849,982, filed on Sep. 4, 2007, now abandoned.
Application No. 11/849,982 is a continuation of application No. PCT/KR2006/000739, filed on Mar. 3, 2006.

(30) Foreign Application Priority Data
Mar. 4, 2005 (KR) 10-2005-0018309
Mar. 3, 2006 (KR) 10-2006-0020346

(51) Int. Cl. G06F 16/951

(52) U.S. Cl. CPC G06F 16/951

(57) ABSTRACT

Disclosed is a method, system, and server for providing an information search service. The method of providing a group search service includes: creating patterns of position information of collected data by analyzing the position information concerning positions on which the collected data is initially located; grouping the collected data into data groups based on the created position information patterns; and selecting a data group related to a keyword from among the data groups and providing a group search result.

### TECHNICAL FIELD

The present invention relates to an information search service and, more particularly, to a method, system, and server for providing an information search service using a group of pages.

### BACKGROUND ART

With the development of the Internet, Internet information search techniques have been greatly improved so that an enormous amount of information can be processed and accumulated on the Internet and users can search for information quickly and accurately.

The Internet information search techniques allow users to use web browsers to easily search for various information, such as images, voice, and moving pictures, on the Internet. However, the search techniques have a disadvantage in that they do not give the users information concerning which includes information necessary to the users among web sites increasing in geometric progression. One of the most general approaches to overcome the disadvantage is using a search engine.

The search engine implies a program designed to help find information stored on a computer system such as the World Wide Web inside a corporate or proprietary network or a personal computer. It makes an index of information of web sites by a search program, such as search robot or web spider, and stores the indexed information in a database. It allows users to ask for content meeting specific criteria (typically those containing a given word or phrase) and retrieves a list of references that match those criteria.

The search engine uses web index method, web directory method, and meta search method. The web index method, one of the most general search methods, makes an index of information on web sites with a search program, such as a search robot or a web spider, stores the indexed information in a database, allows users to ask for content meeting specific criteria, and retrieves a list of references that match those criteria.

The web directory method classifies web pages on the Internet by subjects and layers to compile a database, makes a directory of items, and allows users to select one of the items closest to desired information and to gradually narrow the scope of search.

The meta search method, an advanced web index method, makes a list of search engines providing search services in the web index method, and allows users to select one of the search engines and to make a search.

However, the respective search engines have the following disadvantages. The web directory method cannot obtain substantial search results since a relatively small amount of web pages is obtained as the search result. In addition, the web directory method takes a long time to make a search since it takes a plurality of steps to acquire information. The web index method and meta search method may make users confused about a huge amount of search results, and have a low reliability in search result since the users are provided with all web pages including a query.

The meta search method and web index method use their own algorithms to provide web pages having a high reliability in the first place. However, the web pages may not provide the users with their desired information since all the web pages including the query are provided.

For instance, the above-mentioned search methods provide a page of a book containing information instead of providing one or more books containing information, such that a comprehensive search is not possible. Accordingly, in order to overcome a low reliability in search result, additional content, such as Internet caf, blog, or information service, has been used in addition to the search engine.

### DISCLOSURE OF INVENTION

### Technical Solution

The present invention provides a method, system, and server for providing an information search service, which indexes a group of web pages meeting specific criteria and makes a search in groups of web pages.

### Advantageous Effects

According to the present invention, it is possible for users to search for information on the Internet accurately and quickly since a plurality of web pages is analyzed to create a position information pattern, web pages containing similar information are grouped into groups using the position information pattern, and a plurality of web pages containing the information related to a query, i.e., a representative page and lower-level pages, are grouped and provided to the users.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a system for providing an information search service using a group of pages according to an embodiment of the present invention;

FIG. 2 is a block diagram of a group search server according to an embodiment of the present invention;

FIGS. 3 and 4 are views for explaining a URL pattern and a UP tree according to an embodiment of the present invention;

FIG. 5 is a flow chart of a method of providing an information search service using a group of pages according to an embodiment of the present invention; and

FIG. 6 is a group search result according to an embodiment of the present invention.

### BEST MODE FOR CARRYING OUT THE INVENTION

According to an aspect of the present invention, there is provided a method of providing a group search service, including: (a) creating patterns of position information of collected data by analyzing the position information concerning positions on which the collected data is initially located; (b) grouping the collected data into data groups based on the created position information patterns; and (c) selecting a data group related to a keyword from among the data groups and providing a group search result.

According to another aspect of the present invention, there is provided a method of providing a group search service in a system that includes a user terminal transmitting a query and outputting a search result, a web server providing a plurality of web pages, and a group search server receiving the query from the user terminal and creating and transmitting the search result to the user terminal, the method including: (a) receiving the query and a query request signal from the user terminal; (b) receiving the web pages from the web server; (c) analyzing the web pages to create a URL pattern, and using the URL pattern to group the web pages into a web page group; (d) extracting an index from the web page group and creating index information and URL information of the web page group referenced by the index; and (e) comparing the query with the index to create a group search result and transmitting the group search result to the user terminal.

According to another aspect of the present invention, there is provided a system for providing a group search service obtained by searching information in a plurality of web pages on a wireless/wireline communication network, including: a user terminal performing web surfing over the wireless/wireline communication network, making a search request by transmitting a query and a search request signal, receiving a group search result corresponding to the search request, and outputting the group search result to a display unit; a web server creating the web pages from the information and providing the web pages; and a group search server receiving and analyzing the web pages to create a URL pattern, using the URL pattern to group the web pages into a web page group and indexing the web page group, searching the information in the web page group and creating and transmitting the group search result to the user terminal.

According to another aspect of the present invention, there is provided a group search server including: a position information pattern creation module creating patterns of position information of collected data by analyzing the position information concerning positions on which the collected data is initially located; a page-grouping module grouping the collected data into data groups based on the created position information patterns; and a controller selecting a data group related to a keyword from among the data groups and providing a group search result.

According to another aspect of the present invention, there is provided a group search server receiving a query and a search request signal from a user terminal performing web surfing over a wireless/wireline communication network, searching for information on a web page provided by a web server, and transmitting a search result to the user terminal, the group search server including: a web page collection module executing a web page collection program to receive from the web server the web pages provided by the web server accessing the wireless/wireline communication network and to store the web pages; a URL pattern creation module analyzing the web pages received by the web page collection module to create the URL pattern; a page-grouping module using the URL pattern created by the URL pattern creation module to group the web pages into a web page group; an index management module extracting an index from the web page group grouped by the page-grouping module to create and store index information and URL information of the web page group referenced by the index; a query management module searching the index information upon receiving the query and the search request signal, creating as a group search result the URL information of the web page group having an index related to the query, and transmitting the group search result to the user terminal; and a controller controlling the web page collection module, the URL pattern creation module, the page-grouping module, the index management module, and the query management module so that the group search server can use the web page group to make a search, and controlling so that the group search server can communicate with the user terminal and the web server over the wireless/wireline communication network.

### Mode for the Invention

Exemplary embodiments in accordance with the present invention will now be described in detail with reference to the accompanying drawings.

FIG. 1 is a block diagram of a system for providing an information search service using a group of pages according to an embodiment of the present invention.

A system for providing an information search service using a group of pages according to an embodiment of the present invention includes a user terminal 110, a wireless/wireline communication network 120, a web server 130, a group search server 140, a group search database (hereinafter referred to as ‘DB’) 141, an index server 150, and an index DB 151.

The user terminal 110 accesses the group search server 14 over the wireless/wireline communication network 120, transmits a query and a search request signal, receives a group search result from the group search server 140, and outputs the group search result to a display unit.

The user terminal 110 includes a wireline communication unit including an Internet modem, such as Very High Data Rate Digital Subscriber Line (VDSL) modem and cable modem, and/or a mobile communication unit including a mobile communication modern, such as Code Division Multiple Access (CDMA) 2000 modem and Wideband CDMA (W-CDMA) modem, to access the group search server 140 over the wireless/wireline communication network 120. The user terminal further includes a controller including a memory storing web browser programs for receiving a query from a user, requesting information search, and outputting search results to a display unit, and a microprocessor controlling the operation of the user terminal 110.

Examples of the user terminal 110 include a personal computer (PC), such as desktop or laptop, and a mobile communication terminal, such as Personal Digital Assistant (PDA), cellular phone, Personal Communication Service (PCS) phone, hand-held PC, Global System for Mobile (GSM) phone, W-CDMA phone, CDMA-2000 phone, and Mobile Broadband System (MBS) phone.

The wireless/wireline communication network 120 connects the user terminal 110, web server 130, group search server 140, and index server 150 to one another in wireless or wireline manner to repeat data transmitted and received therebetween.

The web server 130 is a typical network server including a plurality of computer systems or computer software, which provides various information in web pages. The network server implies a computer system and computer software (network server program) that is connected to a sub-unit communicating with another network server over a computer network such as a private intranet or the Internet, receives an operation request, and provides operation results. However, in addition to the network server program, the network server should be construed to include application programs executed on the network server, and various databases stored therein. The network server may be embodied using network server programs offered according to an operating system, such as DOS, Windows, Linux, UNIX or MacOS.

The index server 150 executes a data collection program, which is typically referred to as a web robot, to collect data from the web servers 130 connected to the wireless/wireline communication network 120. The index server 150 updates the collected data periodically, and the index DB 151 stores the collected data using an inverted file or the like.

The group search server 140 communicates with the index server 150 and the index DB 151 to read web data and analyzes position information of the web data to create a plurality of position information patterns. The position information implies information including Internet paths of the collected web data. It preferably includes Uniform Resource Locators (URLs) of the web data. It analyzes a relation between the position information patterns to perform a grouping process. The above-mentioned process may include establishing a relation between a plurality of unequal URL patterns using a URL pattern tree (hereinafter referred to as ‘UP tree’) and grouping web pages having an equal grouping field value of URL pattern. Alternatively or additionally, the process of creating and grouping the URL patterns may include referencing a predetermined URL pattern dictionary.

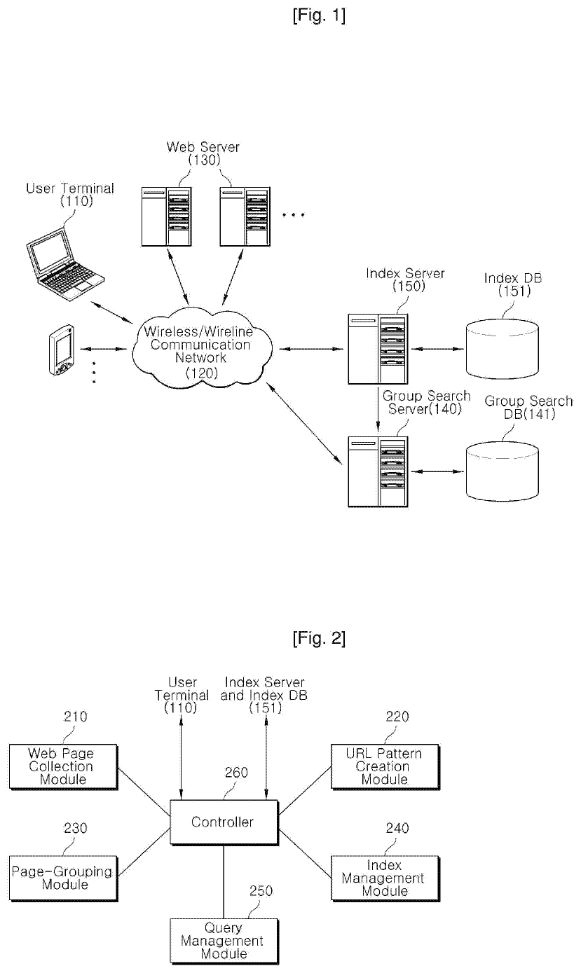

The group search server 140 extracts indexes in web page group units, creates index information and URL information of the web page group referenced by the indexes, and stores the index information and URL information in the group search DB 141. When the group search server 140 receives a query and an information search request signal from the user terminal 110, it compares the query with the index to create information concerning group search results. The group search results, together with other search results related to the query, may be transferred to the user terminal 110. The group search server 140 will he described in detail with reference to FIG. 2.

Even though the group search server 140 does not receive the search request signal from the user related to the query, it may be used to provide a group search result related to a certain keyword. For instance, it may use a higher-level concept containing a user's query or a certain keyword related to the user's query to provide a group search result. Further, it may use a keyword related to news to provide a group search result.

The group search DB 141 stores the index information and position information (including URL information) of a group of web pages, which are created by the group search server 140. It may further store a headword of the group. The DB implies a data structure configured in a storage area of a computer system through a Database Management System (DBMS) program, in which data is retrieved, deleted, edited, and added. The DB may be adapted to the present invention using a Relational Database Management System (RDBMS), such as Oracle, Informix, Sybase, Microsoft Structured Query Language (MS SQL), or DB2. The DB includes fields or elements required in storing, retrieving, deleting, editing, and adding data. Further, the group search DB 141 and the index DB 151 may be separated from each other, or be integrated.

FIG. 2 is a block diagram of a group search server according to an embodiment of the present invention.

A group search server 140 is a network server including a web page collection module 210, a URL pattern creation module 220, a page-grouping module 230, an index management module 240, a query management module 250, and a controller 260.

The web page collection module 210 accesses the web servers 130 over the wireless/wireline communication network 120 to collect data. The web page collection module 210 may be selectively included in the group search server 140 to reflect a change in data referenced by position information that is collected by the index server 150 and stored in the index DB 151.

The URL pattern creation module 220 analyzes URLs of web pages acquired by the controller 260 or web page collection module 210 to create URL patterns. The URL pattern implies a predetermined pattern of URL of a web page, and is created to manage a group of web pages having similar content or written in similar pattern. In the present invention, similar web pages are grouped and managed for information search, At this time, the URL pattern is used as a criterion required in selecting similar web pages.

The URL pattern creation module 220 analyzes URLs of web pages received by the controller 260 or web page collection module 210 to create a URL pattern including a grouping field. For instance, in SayClub homepage service provided by Neowiz Corporation, a URL of a representative page of each ID is analyzed and ID is set as a grouping field, thereby creating a URL pattern of “http://hompy.sayclub.com/[ID].” The URL pattern will be described in detail with reference to FIG. 3. The URL pattern may be created based on HyperText Markup Language (HTML) template shared by web pages or content of the web pages, in addition to the grouping field.

The HTML template implies a frequently used basic structure so that web pages can be easily written. For instance, it is written in tag form, such as <Table . . . ><TD>[text number]</TD> <TD>[title]</TD> . . . </TABLE>, that is frequently used upon writing web pages.

An HTML document written as a web page is typically a combination of an HTML tag and a text, which comply with HTML syntax. The HTML document consists of a plurality of function blocks, such as a menu block, a link block for connection with other portal sites, and a message block for containing texts. The function blocks are frequently used in web pages and are therefore written in templates for convenience of users.

Web pages created by the same operator may be included in a plurality of pages that is managed by a web server offering board service, blog service, mini homepage service, and the like. That is, a plurality of web pages sharing an equal HTML template tends to be created by the same operator and to include similar content.

Since the web server 130 offering the board service, blog service, and mini homepage service uses the HTML template to write most web pages managed by the web server 130, web pages managed by the same web server 130 share the same HTML template. Accordingly, the web pages sharing the same HTML template may have the same URL pattern.

The page-grouping module 230 groups different URL patterns created by the URL pattern creation module 220 based on a relation between the URL patterns acquired through UP tree information, and groups web pages having an equal grouping field among the group of URL patterns. That is, the page-grouping module 230 groups URL patterns, which are different from but related with one another among URL patterns created by the URL pattern creation module 220, based on a relation between the URL patterns acquired through the UP tree information, and groups web pages having an equal grouping field value of URL pattern among the group of URL patterns.

For example, URLs of web pages registered in the SayClub homepage can be generalized in about twenty different URL patterns. The twenty different URL patterns are grouped. into a single group based on the UP tree information. Among them, web pages having a user ID as a grouping field value are grouped into a web page group. Accordingly, when the web pages registered in the SayClub homepage are grouped according to the user ID, the number of groups of web pages is equal to the number of the number of user IDs registered in the SayClub homepage. Further, this may be equally applied to web pages registered in Naver blog, such that the number of groups of web pages is equal to the number of user IDs registered in the Naver blog.

However, in the present invention, a criterion for grouping web pages is not limited to the grouping field value. For example, the web pages may be grouped by performing ‘AND’ or ‘OR’ operation on the grouping fields. The present invention may further include evaluating a connection between an index extracted from the index management module 240 and a corresponding group to subdivide or change a group of pages. For example, when an index extracted from a group of pages is related to two or more fields, the pages may be integrated into a single group or subdivided into two or more subgroups based on the fields. When an index extracted from a group of pages incorrectly represents its content, the group may be deleted for a reliable search result.

The index management module 240 extracts an index from a group of web pages grouped by the page-grouping module 230 and stores index information and URL information of the web pages in the group search DB 141. That is, the index management module 240 extracts an index from a group of web pages to create index information and stores the index information in the index DB 151 of the group search DB 141. In addition, the index management module 240 uses UP tree information to create URL information of the group of web pages and stores the URL information in the group search DB 141.

The query management module 250 searches for the index DB 151 upon receiving a query or keyword from the user terminal 110, receives from the group search DB 141 URL information of a group of web pages having an index that matches the query, and creates group search results. The matching process between the query or keyword and the index may be performed using a prescribed terms dictionary or a mutual information (MI) value. In addition, it may be performed using well-known algorithms.

The controller 260 controls the web page collection module 210, URL pattern creation module 220, page-grouping module 230, index management module 240, and query management module 250 so that the group search server 140 can use a group of web pages to make a search. In addition, the controller communicates with the index server 150 and the index DB 151, receives a query search request signal from the user terminal 110, and transmits group search results.

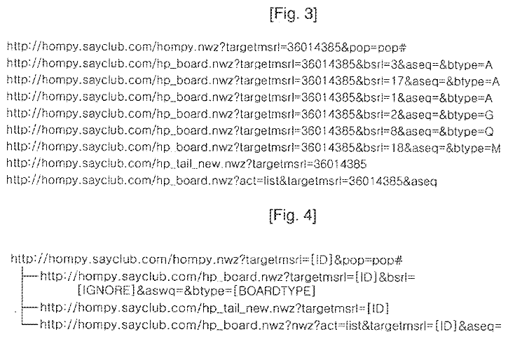

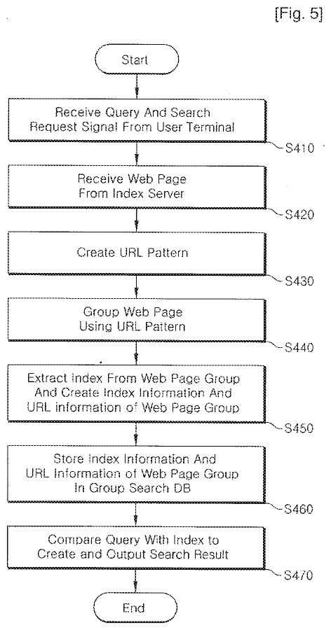

FIGS. 3 and 4 are views for explaining a URL pattern and a UP Tree according to an embodiment of the present invention.

FIG. 3 illustrates a URL of a homepage of a user using the Neowiz SayClub homepage (http://hompy.sayclub.com, hereinafter referred to as ‘hompy’) services, and URLs of its related pages. The hompy of the user includes a plurality of web pages each including user ID in its URL. In case of the SayClub hompy, the URL is represented in query form, i.e., a symbol ‘?’ followed by ‘variable name=variable value’. Accordingly, when values following ‘targetmsr1=’ are regarded as a criterion for identifying user ID in FIG. 3, URL patterns are created as shown in FIG. 4. In addition, in case of private blog service or board service offered by a portal site, a domain of a service provider may be followed by a delimiter to distinguish the user and the board.

FIG. 4 is a URL pattern in a tree structure obtained by analyzing URLs of web pages in a hompy. Referring to FIG. 3, each of the web pages includes user ID in its URL. Thus, among the URLs of web pages, a ‘user ID’ part may be converted to a grouping field of [ID], and a ‘board type’ part included in the hompy may be converted to a grouping field of [boardtype]. When content to be browsed by URL is not substantially changed even though a value of a grouping field is changed, the grouping field may be set as a [IGNORE] field that is ignored in a process of grouping URL patterns. A precedence between the grouping fields may be determined by analyzing inclusion or link between documents within corresponding groups based on a change in values of the grouping fields.

When URL patterns are created through the above-mentioned process, the created URL patterns can be used to generalize web pages of all users of the Neowiz hompy. The grouping fields can be automatically configured in a process of analyzing URL addresses. In case of private blogs or boards offered by a portal site or community site, URL patterns are uniformly created according to a service provider's policy. In this case, the process of creating and grouping the URL patterns can be performed by referencing predefined URL patterns and dictionary concerning the grouping fields.

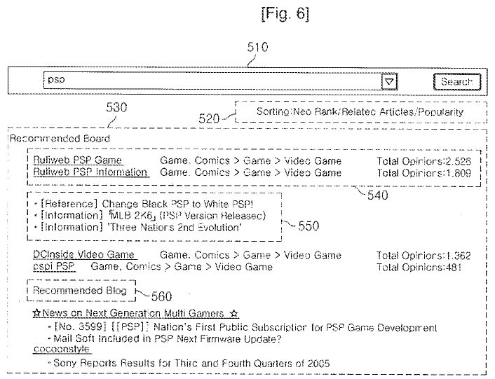

FIG. 5 is a flow chart of a method of providing an information search service using a group of pages according to an embodiment of the present invention.

An Internet user uses the user terminal 110 to input a query for information search, and transmits the query and a search request signal to the group search server 140 (operation S410). The operation S410 may be omitted. That is, a group search service may be performed by analyzing stored data without inputting the query or query request signal from the user. After receiving the query and search request signal from the user terminal 110, the group search server 140 receives information (including address information) related to web pages from the index DB 151 collected and compiled by the index server 150 beforehand (operation S420). The group search server 140 may selectively operate the web page collection module 210 to receive supplementary materials from the index DB 151.

Meanwhile, a web robot program may be executed according to a predetermined method without receiving the query or search request signal from the user to receive web pages and store data. The received data is stored in the index DB 151 through the index server 150.

After receiving the web pages from the index server 150, the group search server 140 analyzes the web pages to create URL patterns (S430).

After creating the URL patterns, the group search server 140 groups different URL patterns based on a relation between the URL patterns acquired through UP tree information, and groups web pages having an equal grouping field value of URL pattern in a group of the URL patterns (operation S440).

After grouping the web pages, the group search server 140 extracts an index from the group of web pages in group units to create index information and URL information of the group of web pages referenced by the index (operation S450), and stores the index information and the URL information of the group of web pages in the group search DB 150 (operation S460).

After storing the index information and the URL information of the group of web pages in the group search DB 150, the group search server 140 compares the query received from the user terminal 110 with the index stored in the group search DB 150, makes a search, creates and transmits group search results to the user terminal 110 (operation S470).

After receiving the search results from the group search server 140, the user terminal 110 outputs the search results to a display unit. The group search service according to the present invention can be provided even though the query is not input from the user.

The group search service according to the present invention groups a plurality of web pages into a web page group and searches for a subject related to the web pages, instead of searching for a term contained in a web page. The search service may be used together with a board search service.

Recently, board services are widely used on web pages, in which users register materials concerning specific information, and write questions and answers about the information. The board services may include web pages containing more information than the users search for.

Accordingly, when a user inputs a query to request a search, a representative web page and lower-level web pages of boards sharing information related to the query are grouped together and provided in a predetermined order, instead of simply providing web pages containing the query.

The group search service according to an embodiment of the present invention is hereinafter assumed to be a board service. However, the present invention is not limited thereto but may be applied to various services for using a group of web pages to make a search.

FIG. 6 is a view for explaining a group search result according to an embodiment of the present invention.

Upon providing a group search result, its output order may depend on a connection between user query and keyword, number of documents in a group, increased amount of documents in a group during an available period, created time of a group and group documents, or popularity such as the number of accesses of users to individual groups. In order to evaluate the connection, an evaluation technique may be used in which frequency in use of the user query and keyword in a corresponding group and a predefined terms dictionary are used. The popularity may depend on the number of inquiries of documents in a corresponding group, the number of accesses of users to groups, and the amount of data created in a group during a predetermined time.

When a user inputs a query “psp” in an input window 510 in a web page that is output to the user terminal 110 to provide a group search service and selects a ‘search’, a group search result 530 is output. The group search result 530 is sorted in ‘Neo rank order’ in a sorting menu 520. The user may sort the group search result 530 in ‘related article order’ or ‘popularity order’ in the sorting menu 520.

The group search result 530 may display a name of a group of web documents, titles of articles, and the like to efficiently provide information. Page group information 540 may further include information concerning sorting of page groups and the number of included documents. In addition, a list 550 of individual documents in individual page groups may be provided for user convenience. Further, classified items 560 concerning information sources of the individual page groups may be provided to efficiently provide information.

While the present invention has been described with reference to exemplary embodiments thereof, it will be understood by those skilled in the art that various changes in form and details may be made therein without departing from the scope of the present invention as defined by the following claims.

### INDUSTRIAL APPLICABILITY

The present invention can be efficiently adapted to a method, system, and server for providing an information search service.

1. A method of providing a group search service, comprising:
(a) creating patterns of position information of collected data by analyzing the position information concerning positions on which the collected data is initially located;
(b) grouping the collected data into data groups based on the created position information patterns; and
(c) selecting a data group related to a keyword from among the data groups and providing a group search result.

2. The method of claim 1, wherein the position information includes Uniform Resource Locator (URL) information of the collected data, and the position information pattern includes a grouping field for grouping the data as a predetermined pattern shared by the collected data.

3. The method of claim 1, wherein the operation (b) comprises:
(b1) grouping the different position information patterns based on a relation between the position information patterns acquired through position information pattern tree information to create a group of the position information patterns; and
(b2) grouping web pages into a web page group based on the grouping field of the position information pattern among the group of position information patterns.

4. The method of claim 1, wherein the group search result is obtained depending on at least one of a correlation between each of the data groups and the keyword, the number of documents created during a predetermined time, and the number of accesses to each of the data groups.

5. The method of claim 3, wherein the group search result depends on at least one of a correlation between each of the data groups and the keyword, the number of documents created during a predetermined time, and the number of accesses to each of the data groups.

6. The method of claim 1, further including collecting data on the Internet beforehand and indexing the collected data before the operation (a).

7. A method of providing a group search service in a system that includes a user terminal transmitting a query and outputting a search result, a web server providing a plurality of web pages, and a group search server receiving the query from the user terminal and creating and transmitting the search result to the user terminal, the method comprising:
(a) receiving the query and a query request signal from the user terminal;
(b) receiving the web pages from the web server;
(c) analyzing the web pages to create a URL pattern, and using the URL pattern to group the web pages into a web page group;
(d) extracting an index from the web page group and creating index information and URL information of the web page group referenced by the index; and
(e) comparing the query with the index to create a group search result and transmitting the group search result to the user terminal.

8. The method of claim 7, wherein the operation (c) comprises:
(c1) analyzing the web pages to create a plurality of URL patterns;
(c2) grouping the different URL patterns based on a relation between the URL patterns acquired through URL pattern tree (UP tree) information to create groups of the URL patterns; and
(c3) grouping web pages into the web page groups based on grouping fields of the URL patterns.

9. The method of claim 7, wherein the operation (d) comprises:
(d1) extracting an index from the web pages included in the web page group to create index information and storing the index information in a group search database (DB); and
(d2) storing the URL information of the web page group referenced by the index in the group search DB so that the URL information can correspond to the index.

10. The method of claim 7, wherein the operation (e) comprises:
(e1) searching the index related to the query;
(e2) searching the URL information of the web page group referenced by the index searched in the operation (e1);
(e3) creating the URL information of the web page group searched in the operation (e2) as a group search result; and
(e4) transmitting the group search result to the user terminal.

11. The method of claim 7, wherein the group search result is obtained depending on at least one of a correlation between each of the data groups and the keyword, the number of documents created during a pre-determined time, and the number of accesses to each of the data groups.

12. A system for providing a group search service obtained by searching information in a plurality of web pages on a wireless/wireline communication network, comprising:
a user terminal performing web surfing over the wireless/wireline communication network, making a search request by transmitting a query and a search request signal, receiving a group search result corresponding to the search request, and outputting the group search result to a display unit;
a web server creating the web pages from the information and providing the web pages; and
a group search server receiving and analyzing the web pages to create a URL pattern, using the URL pattern to group the web pages into a web page group and indexing the web page group, searching the information in the web page group and creating and transmitting the group search result to the user terminal.

13. The system of claim 12, wherein the group search server comprises:
a web page collection module executing a web page collection program to receive from the web server the web pages provided by the web server accessing the wireless/wireline communication network and to store the web pages;
a URL pattern creation module analyzing the web pages received by the web page collection module to create the URL pattern;
a page-grouping module using the URL pattern created by the URL pattern creation module to group the web pages into a web page group;
an index management module extracting an index from the web page group grouped by the page-grouping module to create and store index information and URL information of the web page group referenced by the index;
a query management module searching the index information upon receiving the query and the search request signal, creating as a group search result the URL information of the web page group having an index related to the query, and transmitting the group search result to the user terminal; and
a controller controlling the web page collection module, the URL pattern creation module, the page-grouping module, the index management module, and the query management module so that the group search server can use the web page group to make a search, and controlling so that the group search server can communicate with the user terminal and the web server over the wireless/wireline communication network.

14. The system of claim 12, wherein the URL pattern creation module creates the URL pattern used as a criterion for grouping the web pages in a predetermined pattern shared by web pages having similar information among the web pages, the URL pattern including a grouping field for grouping the web pages.

15. The system of claim 12, wherein the page-grouping module groups the different URL patterns based on a relation between the URL patterns acquired through UP tree information to create groups of the URL patterns, and groups web pages having the same grouping field of URL patterns among the groups of URL patterns into the web page group. 16, The system of claim 12, wherein the page-grouping module groups, as the web page group, web pages having the same values obtained by performing ‘AND’ or ‘OR’ operation on the grouping fields of the URL patterns.

17. The system of claim 12, wherein the index management module extracts an index from the web pages included in the web page group to create and store index information, and
creates and stores the URL information of the web page group referenced by the index so that the URL information can correspond to the index.

18. The system of claim 12, further including a group search DB including an index DB storing the index information received from the group search server, and a URL DB storing URL information of the web page group.
